(19) United States
(12) Patent Application Publication
(10) Pub. No.: US 2026/0024119 A1
(43) Pub. Date: Jan. 22, 2026

(54) STORE SYSTEM WITH AUTOMATED CUSTOMER REPLY AND CUSTOMER BEHAVIOR TRACKING

(71) Applicant: Toshiba Tec Kabushiki Kaisha, Tokyo (JP)

(72) Inventor: Tomoharu NAGAI, Ota Tokyo (JP)

(21) Appl. No.: 19/209,429

(22) Filed: May 15, 2025

(30) Foreign Application Priority Data
Jul. 16, 2024 (JP) 2024-113613

(51) Int. Cl. G06Q 30/02; G06Q 30/015; G06V 20/52

(52) U.S. Cl. CPC G06Q 30/0281; G06Q 30/015; G06V 20/52

(57) ABSTRACT

According to one embodiment, an information processing apparatus for a store system includes a communication interface connected to a network, a storage unit, and a processor. The processor receives, via the communication interface, a customer request from a customer in a store, then generate a reply text in response to the customer request. The reply text is generated using a generative AI based on a prompt corresponding to the customer request. The processor then supplies a customer response to the customer based on the generated reply text, and then receives customer behavior information and tracks a behavior of the customer in the store after the customer response has been supplied. The processor records, in the storage unit, the customer behavior information representing the tracked behavior of the customer in correlation with the customer response supplied to the customer.

### CROSS-REFERENCE TO RELATED APPLICATION

This application is based upon and claims the benefit of priority from Japanese Patent Application No. 2024-113613, filed Jul. 16, 2024, the entire contents of which are incorporated herein by reference.

### FIELD

Embodiments described herein relate generally to store systems for retail environments that include automated customer question reply generation and customer behavior tracking, and apparatuses and methods associated therewith.

### BACKGROUND

Recently, generative artificial intelligence (AI) for generating text, images, and the like has attracted attention. It is getting more common for generative AI to be used to answer to a customer's inquiry about a product or the like, and when a promotion for new merchandise that corresponds to the details of the inquiry, the generative AI may generate text for promoting the new merchandise to the customer. The accuracy of the generative AI in such applications is generally getting higher each day.

However, as a known problem, the generative AI may output a wrong answer to the customer or be unable to answer a customer question not already contained in learning (training) data. For example, in response to an input text “tell me who the current prime minister is”, the generative AI may answer with a name of a person other than the current prime minister because the name of the current prime minister was not provided in the learning to the generative AI in advance.

In order to increase the accuracy of the text responses generated by a generative AI, it may be important to comprehend whether the output text caused a behavior change of a customer. However, in related art systems, a determination as to whether the generated text provided useful information to the user is not generally made.

### BRIEF DESCRIPTION OF THE DRAWINGS

FIG. 1 is a system chart showing an example of a connection relationship among respective devices of a system according to an embodiment.

FIG. 2 is a block diagram showing an example of a hardware configuration of a store computer according to an embodiment.

FIG. 3 is a block diagram showing an example of a functional configuration of a store computer according to an embodiment.

FIG. 4 is a flowchart showing an example of processing executed by a store computer according to an embodiment.

### DETAILED DESCRIPTION

The present disclosure provides a technological solution and/or improvement for an information processing apparatus and a program related to increased accuracy of the information output from a generative AI for store systems in retail environments that include automated customer question reply generation and customer behavior tracking.

In general, according to one embodiment, an information processing apparatus includes a communication interface connectable to a network, a storage unit, and a processor. The processor is configured to: receive, via the communication interface, a customer request from a customer in a store; generate reply text in response to the customer request, the reply text being generated using a generative AI based on a prompt corresponding to the customer request; supply a customer response to the customer based on the generated reply text; receive customer behavior information for the customer and track a behavior of the customer in the store after the customer response has been supplied to the customer; and record, in the storage unit, the customer behavior information representing the tracked behavior of the customer in correlation with the customer response supplied to the customer.

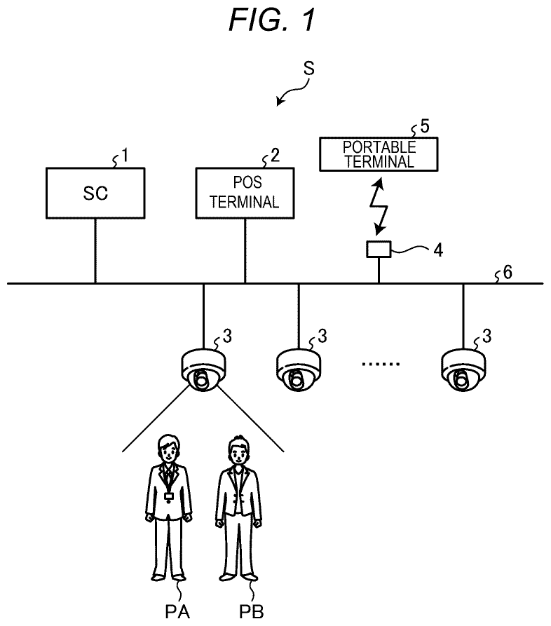

An information processing apparatus and a program of an example embodiment will be explained with reference to FIGS. 1 to 4. Note that, in the following example, a store computer (SC), that is a computer installed in a store, such as a department store or a supermarket, will be explained as an example of an information processing apparatus, however, the present disclosure is not limited thereto.

FIG. 1 is a system chart showing an example of a connection relationship among respective devices of an information processing system S according to an embodiment. In FIG. 1, the system includes a store computer (SC) 1, a point of sales (POS) terminal 2, a plurality of cameras 3, and a portable terminal 5.

The SC 1, the POS terminal 2, and the plurality of cameras 3 are connected to one another via a communication line 6 (e.g., a local area network (LAN)). The portable terminal 5 is connected to the SC 1 via an access point 4, such as a repeater for wireless communication, and the communication line 6.

Note that the numbers of the different devices shown in FIG. 1 are examples and the numbers of the devices provided in the system are not limited to the numbers shown in FIG. 1. For example, the system may include multiple access points 4 and multiple portable terminals 5.

The POS terminal 2 is a sales data processing device that executes sales registration processing on merchandise being purchased in a store. For example, the POS terminal 2 may be a dedicated self-service POS terminal, a smartphone, a cart POS, or the like. Note that the POS terminal 2 is not limited to a self-service device. For example, the POS terminal 2 may be a device for a store clerk to perform the sales registration processing.

The POS terminal 2 generates and then transmits merchandise sales registration information to the SC 1 via the communication line 6.

The SC 1 is a server device that collects and manages the merchandise sales registration information received from the POS terminal 2. The SC 1 may comprise a single server device or a plurality of server devices working in concert. Or, the SC 1 may be a cloud server. Note that the SC 1 may be provided on a network outside the store in some examples.

The SC 1 stores merchandise information including prices, names, etc. of merchandise sold in the store.

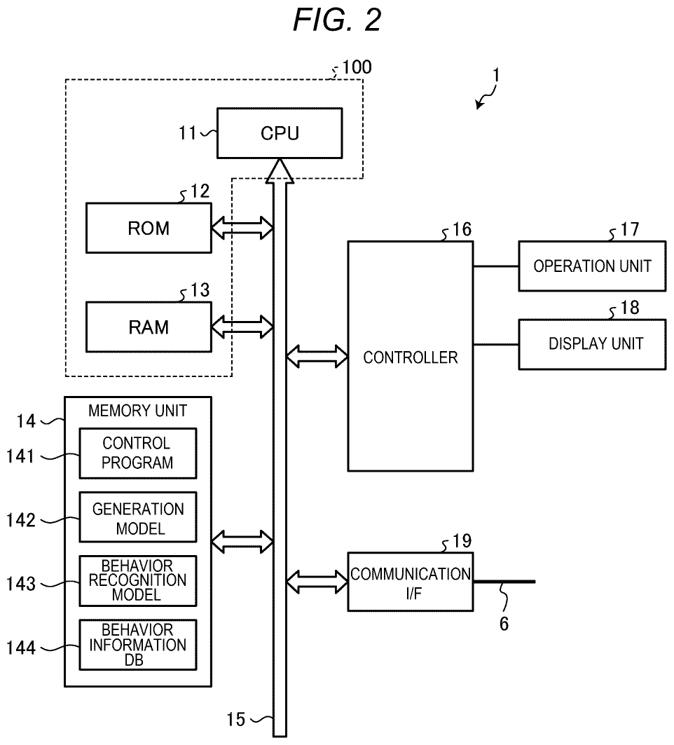

The SC 1 also accepts the input of a demand text (request) representing a demand (request) from a customer via the portable terminal 5. This demand text may be referred to as a customer demand, a customer question, or a customer request in some contexts. The SC 1 then inputs the demand text to a generation model 142 (see FIG. 2) to generate a reply text to the demand. The SC 1 generates response information based on the generated reply text and transmits the information to the portable terminal 5.

The SC 1 sends images (for example, video frames or a time-series of moving images)) of the customer as captured by a camera 3 to a behavior recognition model 143 (see FIG. 2). The SC 1 generates a behavior text describing a behavior of the customer in the images. The behavior text is output from the behavior recognition model 143 in response to the images supplied thereto. For example, a behavior text is text data describing a movement route of the customer in the store and the merchandise purchased or selected by the customer. The SC 1 correlates and stores the response information with the generated behavior text.

Each camera 3 captures an image depicting customers within the store. For example, the cameras 3 may be placed along aisles at fixed intervals on a ceiling or the like to capture images of the customers shopping or moving in the store.

One or more of the cameras 3 may be placed to cover the entry and exit routes of the customers. In FIG. 1, cameras 3 (n total cameras 3 are depicted) are placed along an aisle within the store and these cameras 3 capture video or pictures of a customer PA and a customer PB. The image captured by each camera 3 may contain or be associated with information representing a capturing time and a capturing position (e.g., the placement position of the camera 3 that captured the image) or the like.

The portable terminal 5 in this example is carried by the customer and exchanges information between the SC 1 and itself. The portable terminal 5 is e.g., a smartphone or a tablet terminal. For example, the portable terminal 5 receives input of a demand text from the customer and transmits the demand text to the SC 1. The portable terminal 5 also receives a response information from the SC 1. The portable terminal 5 in this example includes a camera and can transmit an image captured by the camera to the SC 1. For example, the camera of portable terminal 5 can capture an image of the face of the customer operating the portable terminal 5.

Note that, in place of a portable terminal 5, a fixed terminal device such as a personal computer (PC) that can execute the above described processing may be provided.

Next, hardware configurations of the SC 1 will be explained. FIG. 2 is a block diagram showing an example of the hardware configurations of the SC 1.

As shown in FIG. 2, the SC 1 includes a central processing unit (CPU) 11 (also referred to as a main controller), a read only memory (ROM) 12 that stores various programs, a random access memory (RAM) 13 that loads various data, and a memory unit 14 that stores the various programs.

The CPU 11, the ROM 12, the RAM 13, and the memory unit 14 are connected to one another via a data bus 15. The CPU 11, the ROM 12, and the RAM 13 form a control section 100. That is, the control section 100 executes various kinds of processing by the CPU 11 operating according to a control program 141 stored in the ROM 12 or the memory unit 14 and loaded in the RAM 13. The various kinds of processing will be described later.

The RAM 13 not only loads various programs including the control program 141 but also temporarily stores images captured by the cameras 3 until the images are stored in the memory unit 14.

The memory unit 14 is a nonvolatile memory such as a hard disk drive (HDD), a solid-state drive (SSD), or a flash memory that holds memory information even when power is turned off. The memory unit 14 stores programs including the control program 141 and the like. Further, the memory unit 14 stores the generation model 142, the behavior recognition model 143, and a behavior information data base (DB) 144.

The generation model 142 is a generative AI that generates text. The generation model 142 may be a large language model (LLM). The generation model 142 generates reply text corresponding to the demand input of the customer.

For example, the generation model 142 is a LLM configured by deep learning technology that generates reply text corresponding to the demand of the customer in response to input of text data incorporating the demand text.

In some examples, the generation model 142 may be stored in a server device other than the SC 1.

The behavior recognition model 143 is a learned model trained using input training data including images (moving images) of customers and output training data comprising text data describing behaviors of the customers in the images.

As one example, the behavior recognition model 143 may be a model based on a machine learning model such as a neural network having parameters determined by deep learning. For example, a convolutional neural network (CNN) is an option, but another network type may be used.

In an embodiment, the behavior recognition model 143 has a function of outputting feature text data describing behaviors of the customers in the moving images captured by the cameras 3. The appropriate feature data corresponding to depicted behavior(s) of the customers in the moving imaged can be learned by model training.

In some examples, the behavior recognition model 143 may be stored in a server device other than the SC 1.

The behavior information DB 144 is a database that stores information about the behaviors of customers. For example, the behavior information DB 144 correlates and stores a demand text, response information supplied, a face image, and a behavior text to each customer. In some examples, behavior information DB 144 may be stored in a server device other than the SC 1.

An operation unit 17 and a display 18 are connected to the data bus 15 via a device controller 16 (also may be referred to as an I/O interface).

The operation unit 17 accepts various kinds of input from an operator (user), such as a manager of the store. For example, the operation unit 17 includes a numeric for inputting numbers, various function keys, etc.

The display unit 18 displays various kinds of information to the operator. For example, the display unit 18 displays an analysis report. Note that the display unit 18 may also display images acquired from the cameras 3 within the store. Or the display unit 18 may display images captured by a particular camera 3. Or the display unit 18 may display the images captured by multiple cameras 3 on a split screen at the same time.

The data bus 15 connects a communication interface (I/F) 19 such as a LAN I/F. The communication I/F 19 connects to the communication line 6.

The communication I/F 19 transmits and receives various kinds of information. For example, the communication I/F 19 receives the images captured by the cameras 3 in real time.

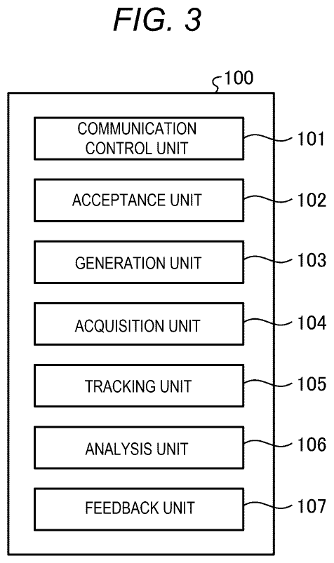

Next, functional configurations of the SC 1 will be explained. FIG. 3 is a block diagram showing an example of the functional configurations of the SC 1. The control section 100 functions, upon of execution software or the like, as a communication control unit 101, an acceptance unit 102, a generation unit 103, an acquisition unit 104, a tracking unit 105, an analysis unit 106, and a feedback unit 107. Such configurations and functions thereof are provided according to various programs including the control program 141 stored in the ROM 12 and/or the memory unit 14.

The communication unit control 101 controls communication between the POS terminal 2 and the portable terminal 5. For example, the communication control unit 101 establishes wireless communication or wired communication between the POS terminal 2 to transmit and receive various kinds of information between the POS terminal 2 and the SC 1. The communication control unit 101 may also establish wireless communication to the portable terminal 5.

The acceptance unit 102 accepts input of demand text (text data representing a demand of the customer) from the customer. For example, the acceptance unit 102 accepts customer input from the customer via portable terminal 5. The demand text transmitted from the portable terminal 5 includes terminal identification information for identification of the particular portable terminal 5 that sent the demand.

The generation unit 103 generates response information (a response to the demand of the customer) based on the demand text. For example, the generation unit 103 generates input text to be supplied to the generation model 142 from the demand text accepted by the acceptance unit 102. The processing for generating the text to be input (supplied) to the generative AI is also referred to in this context as preprocessing.

The input text may be referred to as a prompt, the input of which to the generative AI causes text (e.g., a response, question answer, or other output) to be generated by the generative AI. Hereinafter, the content of the prompt is also referred to as an instruction content or prompt content.

For example, as preprocessing, the generation unit 103 generates an input text (prompt) containing a name of the merchandise to be suggested for the customer to purchase, a description of the merchandise, and information corresponding a behavior to be recommended to the customer within the store. The prompt may also indicate that the merchandise to be suggested is to be limited to merchandise sold in the store, be derived based on overall customer demand (e.g., popular or trending items), and the behavior to be recommended be derived according to the display location of the merchandise.

In this example, a template for generation of the instruction information (prompts) may be stored in the memory unit 14 or the like in advance. Note that a plurality of such templates may be stored in the memory unit 14 or the like. In this case, the generation unit 103 may use different templates depending on the situation. For example, the generation unit 103 may change the template according to a keyword contained in the customer's demand text. For example, a keyword may be a word by which an overall category of the merchandise (food, clothing, or the like) of interest to the customer can be determined.

Note that, in addition, as part of the preprocessing, the generation unit 103 may perform processing for acquiring information about a merchandise purchase history of the customer, and/or for removing or excluding information about merchandise already purchased by the customer from the possible merchandise recommendation(s).

The generation unit 103 acquires a reply text generated by the generation model 142 in response to the input of the input text. The generation unit 103 generates response information by performing processing of adding additional information to the acquired reply text or converting or changing the output format of the reply text or the like. The processing performed on the text generated by the generative AI is also referred to as post-processing.

For example, as post-processing, the generation unit 103 performs processing of converting information representing the location where the merchandise corresponding to the demand of the customer is displayed into information representing a route from the current position of the customer to the merchandise display location or the like. The current location of the customer may be specified from positions of the cameras 3 providing images (video or time-series images) of the customer or may be specified based on radio waves emitted by the portable terminal 5 of the customer.

Note that, in addition, as post-processing, the generation unit 103 may perform processing for incorporating an image of the merchandise to be recommended or converting the generated text data into voice data, such as realistic sounding human-like speech.

The generation unit 103 transmits the reply text after post-processing as response information to the portable terminal 5 in cooperation with the communication control unit 101. The generation unit 103 and the communication control unit 101 are an example of a presentation unit.

In the present example, the generation unit 103 may acquire the reply text generated using a generation model 142 established in a cloud environment, however, the input text may sometimes contain personal information or the like of the customer that might be privacy restricted or limited in a manner that prevents or restricts sharing or external transmission.

Accordingly, in view of prevention of leakage of personal information, it may generally be preferable to use a locally constructed generation model 142 for generation of the reply text.

The acquisition unit 104 acquires a face image (facial image) of the customer who input demand text.

For example, the acquisition unit 104 transmits a face image transmission request for requesting transmission of the face image of the customer whose behavior is to be tracked (also referred to as a tracking target customer) to the portable terminal 5 at the same time as the transmission of the response information. The portable terminal 5 then starts an application for capturing an image and then captures the image of the customer. For example, the portable terminal 5 captures images of the customer until an image is recognized, using a known image recognition technique, as a facial image of the customer.

Note that the portable terminal 5 may request that the customer capture a facial image using the camera provided in the portable terminal 5.

The portable terminal 5 transmits the customer's face image to the SC 1 in response to the face image transmission request. The acquisition unit 104 of the SC 1 acquires the face image in correlation with the response information transmitted from the portable terminal 5 via the communication I/F 19 and the communication line 6. The acquisition unit 104 then sends the acquired face image of the customer to the tracking unit 105.

The tracking unit 105 tracks the behavior of the customer after the response information has been presented. For example, the tracking unit 105 identifies the tracking target customer based on the face image of the customer acquired by the acquisition unit 104, captures additional images of the tracking target customer with the cameras 3, and tracks the behavior of the tracking target customer in moving images captured by the cameras 3.

Specifically, the tracking unit 105 acquires the images or video from the cameras 3 in real time and extracts the images in which people are recognized using a known image recognition technique. Note that the tracking unit 105 may also or instead acquire still images from the cameras 3 at fixed time intervals.

As an example, the tracking unit 105 extracts images containing the customer PA and images containing the customer PB (see FIG. 1) from the video streams provided by the cameras 3. Here, after the acquisition unit 104 acquires the face image of customer PA, the tracking unit 105 may identify the customer PA as a tracking target customer.

After identifying a tracking target, the tracking unit 105 continuously executes image recognition processing for extracting images in which the tracking target customer appears in real time until the tracking target customer is recognized as exiting. The tracking unit 105 continuously executes the processing until the customer PA exits the store.

The tracking unit 105 inputs the extracted images of the tracking target customer to the behavior recognition model 143. In some examples, the tracking unit 105 may input still images acquired in chronological order to the behavior recognition model 143.

The tracking unit 105 acquires behavior text output from the behavior recognition model 143. As an example, the behavior text is narrative text such as “the customer went to the vegetable section and picked up a Chinese cabbage and put it in the shopping basket”.

The behavior text may be simpler, such as “the customer bought a Chinese cabbage”, or be more detailed, such as “the customer went to the beverage section, passed through the aisle at the center of the store to go to the vegetable section, picked up a Chinese cabbage, but returned it to the rack”.

The tracking unit 105 correlates and stores the face image of the customer, the response information provided to the customer, and the acquired behavior text in association with one another in the behavior information DB 144.

Note that, when correlating and storing the face image of the customer, the response information, and the behavior text, the tracking unit 105 may search the behavior information DB 144 using the face image of the customer as a tracking object as a key. If it is found that the information corresponding to the face image is already stored in the behavior information DB 144, the tracking unit 105 may correlate and store the face image of the customer, the response information, and the behavior text in the behavior information DB 144 by appending such information to the information already stored for the customer.

In some examples, the tracking unit 105 may acquire behavior text generated using a behavior recognition model 143 established in a cloud environment, however, since the personal information of the customer may be identified from the images input to the behavior recognition model 143, it may be preferable to use the locally established behavior recognition model 143 for generation of the behavior text.

The analysis unit 106 analyzes whether the response information presented to the customer caused a behavior change in the customer based the behavior text. For example, the analysis unit 106 compares the response information to the behavior text, and calculates how well the customer conformed to the behavior proposed in the response information. Further, the analysis unit 106 calculates how often the customer met a goal proposed in the response information.

As an example, a case where behaviors “go from around the entrance to the beverage section, go from the beverage section to the vegetable section, go from the vegetable section to the fruit section” and goals “buying a beverage A, buying a Chinese cabbage, buying an apple” were proposed in the response information is considered. In this example, the acquired behavior text is “the customer went from around the entrance to the vegetable section, but did not put a Chinese cabbage into the shopping basket, went from the vegetable section to the fruit section and put an apple in the shopping basket, went from the fruit section to the cashier, and made a payment”.

In this case, since the customer followed two proposed behaviors “go to the vegetable section” and “go to the fruit section” out of the three behaviors proposed=, the analysis unit 106 calculates a success rate (or a hit percentage) at which the customer followed the proposed behaviors as ⅔≈66.6%. Since the customer met one proposed goal “buying an apple” out of the three goals proposed in the response information, the analysis unit 106 calculates a success rate (or a hit percentage) at which the customer achieved the goals as ⅓≈33.3%.

Note that the analysis unit 106 may perform other calculations of indexes and values as necessary or appropriate including another rate for when the customer picked up but did not purchase merchandise.

The feedback unit 107 executes processing for improvement of the response information based on the analysis result from the analysis unit 106. For example, the feedback unit 107 presents an analysis report containing the response information that was actually presented to the customer, the behavior text associated with the customer, the success rate for behaviors proposed in the response information, and the success rate for the goals proposed in the response information.

Methods of presenting an analysis report include displaying the analysis report on the display unit 18 of the SC 1, transmitting the analysis report to a terminal used by a user (e.g., a store manager), and printing the analysis report with a printer.

The analysis report allows a user to understand or evaluate the tendencies or trends in the proposals that the customer followed and those the customer did not follow. The user can take actions for improving the response information to be generated in the future such as adding an instruction to add a fixed phrase for facilitating understanding of the proposal in the preprocessing or incorporating related images in post-processing for conveying content that may be harder to be understood when presented only in text. The user may also initiate reinforcement learning for the generation model 142 based on an identified tendency or trend in previous proposals or the like.

Note that the feedback unit 107 may itself automatically execute processing for including an improvement to the preprocessing and the post-processing. The feedback unit 107 may initiate or direct the reinforcement learning of the generation model 142 based on the analysis result by the analysis unit 106. The feedback unit 107 in this case would be an example of a change processing unit. As an example, the feedback unit 107 may generate an input text by adding an instruction that, if a proposed behavior or a goal has a low success probability it becomes less likely to be included in the content of the reply text by collection of analysis results.

Further, if the same behavior (or goal) was proposed to a specific customer multiple times, but the specific customer did not follow the proposal, the feedback unit 107 may generate an input text by adding an instruction not to propose the same behavior (or goal) to the specific customer again.

Thereby, repeatedly making the same proposal to a customer who has demonstrated no intention to follow the proposal can be prevented.

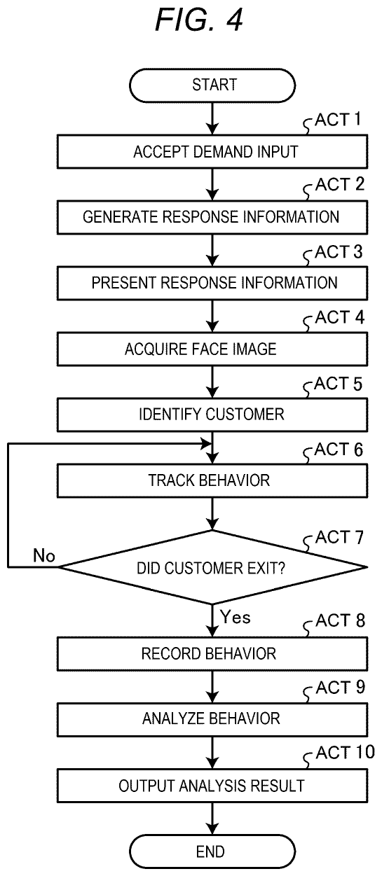

Next, processing executed by the SC 1 will be explained using FIG. 4. FIG. 4 is a flowchart showing an example of the processing executed by the SC 1.

First, the acceptance unit 102 accepts input of a demand from a customer (ACT 1). For example, the acceptance unit 102 accepts demand text from a customer via the communication I/F 19, the communication line 6, and the portable terminal 5 in cooperation with the communication control unit 101. Here, the accepted demand text contains terminal identification information (identification) for the portable terminal 5 that sent the demand.

Then, the generation unit 103 generates response information (ACT 2). For example, the generation unit 103 performs preprocessing on the demand text (received in ACT 1) and generates an input text for the generation model 142, and acquires a reply text generated by the generation model 142 in response to the input text. The generation unit 103 may then perform post-processing on the acquired reply text to generate response information to be supplied/presented to the customer in response to the demand text.

Then, the generation unit 103 presents the response information to the customer (ACT 3). For example, the generation unit 103 transmits the response information (generated in ACT 2) to the portable terminal 5. Then, the portable terminal 5 displays the response information on the display or the like, and thereby, the response information is presented to the user.

Then, the acquisition unit 104 acquires a face image of the customer at the portable terminal 5 (ACT 4), so the customer's subsequent behavior can be tracked.

For example, the acquisition unit 104 transmits a face image transmission request in correlation with the response information (generated in ACT 2) to the portable terminal 5 in parallel with the processing in ACT 3 or the like.

The acquisition unit 104 acquires the face image of the customer from the portable terminal 5 in response to the face image transmission request via the communication I/F 19 and the communication line 6 in cooperation with the communication control unit 101. The face image can now be correlated with the response information (generated in ACT 2).

Then, the tracking unit 105 identifies the customer as a tracking target customer (ACT 5). For example, the tracking unit 105 acquires video in real time from the plurality of cameras 3 within the store. The tracking unit 105 may extract images or video frames in which people appear using the known image recognition technique. The tracking unit 105 identifies a particular tracking target customer in the extracted images/frames based on the face image of the customer acquired in ACT 4.

Then, the tracking unit 105 tracks the behavior of the tracking target customer (ACT 6). The tracking unit 10, for example, provides customer movement information indicating movement of tracking target customer in the store or other behavioral information. For example, the tracking unit 105 continuously executes processing of acquiring real time video or images and extracting those images in which the tracking target customer can be identified using the known image recognition technique.

Then, the tracking unit 105 checks whether the tracking target customer has exited from the store (ACT 7). For example, if the tracking unit 105 determines that the tracking target customer has not exited from the store (ACT 7: No), the processing returns to ACT 6.

On the other hand, if the tracking target customer has exited from the store (ACT 7: Yes), the tracking unit 105 records (stores) the behavior of the tracking target customer within the store (ACT 8).

For example, the tracking unit 105 sends moving image data (extracted in ACT 6) in which the tracking target customer appears to the behavior recognition model 143. The tracking unit 105 then acquires a behavior text from the behavior recognition model 143. The tracking unit 105 stores and correlates the face image of the customer acquired in ACT 4, the response information presented to the customer in ACT 3, and the acquired behavior text from the behavior recognition model 143 with one another in the behavior information DB 144.

The analysis unit 106 can now analyze whether the response information presented to the customer caused a behavior change (ACT 9). For example, the analysis unit 106 compares the response information to the behavior text and calculates a hit rate at which the customer followed the behavior proposed in the response information and a hit rate at which the customer achieved the goal proposed in the response information.

The feedback unit 107 then outputs an analysis result or report (ACT 10) and ends the processing. For example, the feedback unit 107 displays an analysis report containing the response information actually presented to the customer, the behavior text, the hit rate at which the customer followed the behavior proposed in the response information, and the hit rate at which the customer achieved the goal proposed in the response information on the display unit 18.

In FIG. 4, an example in which the feedback unit 107 presents the analysis report is explained, however, in some examples, the feedback unit 107 may itself execute processing for improvement of the response information including adjustments or changes in preprocessing and post-processing and execution of reinforcement learning by the generation model 142 based on the analysis result or report in ACT 9.

As described above, the SC 1, an information processing apparatus according to the embodiment, accepts input of the demand information representing the demand of the customer coming to the store, generates the reply text based on the demand information using the generation model 142 as the generative AI, generates the response information to the demand of the customer based on the reply text, presents the response information to the customer, tracks the behavior of the customer after presenting the response information, and correlates and records the behavior text representing the behavior of the customer obtained by tracking with the response information.

Thereby, in the SC 1, the response information presented to the customer and the actual behavior of the customer are recorded in a manner to facilitate comparisons. For example, a user such as a manager of the store can compare the response information presented to customers to the actual behavior of the customers, and thereby identify and evaluate the appropriateness and validity of replies and responses to customer demands/requests. Further, the user may see the extent to which response information presented to the customer caused a behavior change in the customer. In this case, the user contemplate potential alterations in the response information that might better or more effectively change the behavior of customers and such information may be used for updating or changing the generation model 142. Therefore, according to an embodiment, the accuracy of the information output from the generative AI can be improved.

Note that the above described embodiment can be modified and implemented with various changes in configurations or functions of the SC 1. Accordingly, several modified examples will be explained as other embodiments. In description below, the differences from already described example embodiments will be primarily explained and the explanation of those aspects common to other already explained examples may be omitted. Furthermore, the following modifications may be individually implemented or combined and implemented with one another when appropriate.

### Modified Example

In one embodiment, a mode in which the behavior text for the tracking target customer is generated and stored when the exit of the tracking target customer is recognized is explained. In a modified example, a mode in which a behavior text for the tracking target customer is generated at predetermined time increments based on moving image data during a predetermined time period.

In the modified example, after identifying the tracking target customer, the tracking unit 105 inputs moving image data captured during a predetermined time period (e.g., three minute increments). The moving image data can comprise a plurality of images (frames) in which the tracking target customer appears. The images/frames may be extracted from moving images captured by the cameras 3 during a predetermined time period (e.g., one minute). The moving image data is sent to the behavior recognition model 143. Thereby, the tracking unit 105 can store a behavior text representing the behavior of the tracking target customer in nearly real time in the behavior information DB 144.

Here, the tracking unit 105 may acquire the behavior text generated using a behavior recognition model 143 configured in the cloud environment. However, when a behavior recognition model 143 configured in a cloud environment is used, a network traffic for communication with a cloud server and computing cost for the cloud server are necessary. Furthermore, if the generation of the behavior text is to be performed at short time intervals, lags due to communication between the SC 1 and the cloud server may occur. Such a problem generally does not occur if a locally constructed behavior recognition model 143 is used. Accordingly, it may be preferable that the tracking unit 105 uses a locally constructed behavior recognition model 143 in some examples.

According to this modified example, the behavior of the tracked customer can be analyzed and the processing for improvement of the preprocessing and/or the post-processing can be performed based on the analysis result without waiting for the exit of the tracked customer.

The program executed in the SC 1 of an embodiment may be recorded in a file in an installable format or executable format in a computer-readable non-transitory storage medium such as a CD-ROM, a flexible disk (FD), a CDR, a digital versatile disk (DVD) and provided.

Or the program executed in the SC 1 of an embodiment may be stored in a computer connected to a network such as the Internet, downloaded via the network, and provided thereby. Or the program executed in the SC 1 of an embodiment may be provided or distributed via a network such as the Internet.

Furthermore, the program executed in the SC 1 of an embodiment may be incorporated in the ROM 12 or the like in advance.

In addition, the various described functional aspects such as the communication control unit 101, the acceptance unit 102, the generation unit 103, the acquisition unit 104, the tracking unit 105, the analysis unit 106, and the feedback unit 107 may be implemented by one or more processing circuits including an application specific integrated circuit (ASIC) and/or a field programmable gate array (FPGA).

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An information processing apparatus, comprising:
a communication interface connectable to a network;
a storage unit; and
a processor configured to:
receive, via the communication interface, a customer request from a customer in a store;
generate reply text in response to the customer request, the reply text being generated using a generative AI based on a prompt corresponding to the customer request;
supply a customer response to the customer based on the generated reply text;
receive customer behavior information for the customer and track a behavior of the customer in the store after the customer response has been supplied to the customer; and
record, in the storage unit, the customer behavior information representing the tracked behavior of the customer in correlation with the customer response supplied to the customer.

2. The information processing apparatus according to claim 1, wherein the customer behavior information is customer movement information for the customer in the store.

3. The information processing apparatus according to claim 1, wherein the processor receives images of the customer in the store and tracks, based on the received images, movements of the customer in the store to provide the customer behavior information.

4. The information processing apparatus according to claim 3, further comprising:
an image capturing device in the store, wherein
the images of the customer are provided by the image capturing device.

5. The information processing apparatus according to claim 1, wherein the processor is further configured to generate the prompt by incorporating portions of the received customer request into an instruction to generate text associated with merchandise to be suggested to the customer.

6. The information processing apparatus according to claim 5, wherein the customer response includes a recommended behavior for the customer in the store.

7. The information processing apparatus according to claim 5, wherein the processor is further configured to add additional information to the reply text to generate the customer response.

8. The information processing apparatus according to claim 5, wherein the processor is further configured to change a format of the reply text to generate the customer response.

9. The information processing apparatus according to claim 1, wherein the processor is further configured to change a format of the reply text to generate the customer response.

10. The information processing apparatus according to claim 1, wherein the processor is further configured to:
compare the recorded behavior information to the customer response to detect whether the customer response caused a behavior change in the customer; and
generate an analysis report based on the comparison of the recorded behavior information to the customer response.

11. The information processing apparatus according to claim 10, wherein the processor is further configured to change a method of generating the reply text based on the analysis report.

12. The information processing apparatus according to claim 11, wherein the processor is further configured to change a method of presenting the customer response based on the analysis report.

13. A store system, comprising:
a plurality of cameras positioned to acquire images of customers in a store;
a store server connected to the plurality of cameras via a network; and
a point-of-sale terminal configured to provide sales transaction data to the store server via the network, wherein
the store server includes:
a communication interface connectable to the network;
a storage unit; and
a processor configured to:
receive, via the communication interface, a customer request from a customer using a portable terminal in the store;
generate reply text in response to the customer request, the reply text being generated using a generative AI based on a prompt corresponding to the customer request;
supply a customer response to the customer based on the generated reply text;
receive customer behavior information for the customer and track a behavior of the customer in the store after the customer response has been supplied to the customer; and
record, in the storage unit, the customer behavior information representing the tracked behavior of the customer in correlation with the customer response supplied to the customer.

14. The store system according to claim 13, wherein the customer behavior information is customer movement information for the customer in the store provided by analysis of images from the plurality of cameras.

15. The store system according to claim 13, wherein the processor receives images of the customer from the plurality of cameras in the store and tracks, based on the received images, movements of the customer: in the store to provide the customer behavior information.

16. A non-transitory, computer-readable medium storing program instructions which when executed by a processor of a store server in a store system cause the store server to perform a method comprising:
receiving, via a communication interface, a customer request from a customer in a store;
generating reply text in response to the customer request, the reply text being generated using a generative AI based on a prompt corresponding to the customer request;
supplying a customer response to the customer based on the generated reply text;
receiving customer behavior information for the customer and tracking a behavior of the customer in the store after the customer response has been supplied to the customer; and
recording, in a storage unit, the customer behavior information representing the tracked behavior of the customer in correlation with the customer response supplied to the customer.

17. The non-transitory, computer-readable medium according to claim 16, wherein the customer behavior information is customer movement information for the customer in the store.

18. The non-transitory, computer-readable medium according to claim 16, the method further comprising:
receiving images of the customer in the store and tracking, based on the received images, movements of the customer in the store to provide the customer behavior information.

19. The non-transitory, computer-readable medium according to claim 16, the method further comprising:
comparing the recorded behavior information to the customer response to detect whether the customer response caused a behavior change in the customer; and
generating an analysis report based on the comparison of the recorded behavior information to the customer response.

20. The non-transitory, computer-readable medium according to claim 19, the method further comprising:
changing a method of generating the reply text based on the analysis report.
